(19) United States
(12) Patent Application Publication
(10) Pub. No.: US 2008/0213535 A1
(43) Pub. Date: Sep. 4, 2008

(54) Oriented Zeolite Material and Method for Producing the Same

(75) Inventors: Gion Calzaferri, Bremgarten (CH); Arantzazu Zabala Ruiz, Bern (CH)

Correspondence Address: MCCORMICK, PAULDING & HUBER LLP, CITY PLACE II, 185 ASYLUM STREET, HARTFORD, CT, 06103, US

(73) Assignee: Universitat Bern, Bern (CH)

(21) Appl. No.: 11/997,035

(22) PCT Filed: Jul. 28, 2006
(86) PCT No.: PCT/CH2006/000394

§ 371 Date: Jan. 28, 2008

Related U.S. Application Data
(60) Provisional application No. 60/748,613, filed on Dec. 9, 2005.

(30) Foreign Application Priority Data
Jul. 29, 2005 (CH) 1266/05

(51) Int. Cl. B32B 3/10; B29C 65/00

(52) U.S. Cl. 428/137; 156/299

(57) ABSTRACT

An oriented zeolite material comprises a plurality of zeolite crystals (2) arranged on a substrate (4), each one of said crystals having a proximal face (6) adjacent to said substrate and a distal face (8) opposed therefrom and substantially parallel to said proximal face. Each one of said crystals has a plurality of straight through uniform channels (10) extending between the proximal face and the distal face and having a channel axis parallel to and a channel width transverse to a longitudinal crystal axis A. Each channel has a proximal channel end (12) located at the proximal face and a distal channel end (14) located at the distal face, and each crystal is attached to the substrate by means of a linking layer (16) that substantially occludes the proximal channel ends.

### TECHNICAL FIELD OF THE INVENTION

The present invention relates to an oriented zeolite material and to a method of producing the same.

### BACKGROUND OF THE INVENTION

Sunlight is absorbed in the antenna system of a green leaf where it is trans-ported by supramolecularly organized chlorophyll molecules for the purpose of energy transformation. It is highly desirable to develop a similar light transport in an artificial system comprising, for example, an arrangement of organic dye molecules. However, organic dye molecules have the tendency to form aggregates even at low concentration. These aggregates are known to generally cause fast thermal relaxation of electronic excitation energy.

It has been known for some time that zeolite L crystals are an ideal host system that can be loaded with substantial amounts of dye molecules forming therein a supramolecular organization. The main role of zeolite L is to prevent aggregation of the dye molecules by virtue of its essentially one-dimensional channels. More recently—as disclosed in published international application WO 02/36490 A1—it was found that the applicability and the properties of dye loaded zeolite L materials may be substantially improved by sealing off the channel ends of these materials with appropriate closure or “stopcock” molecules. Such closure molecules have an elongated shape and consist of a head moiety and a tail moiety, wherein the tail moiety has a longitudinal extension of typically more than a dimension of the crystal unit cells along the c-axis and the head moiety has a lateral extension that is larger than the channel width and thus will prevent the head moiety from penetrating into a channel. A channel of the zeolite L material is terminated in generally plug-like manner by a closure molecule whose tail moiety penetrates into the channel and whose head moiety substantially occludes the channel end while projecting over the zeolite L surface.

An even higher level of organization of substantial amounts of dye molecules would be desirable. This could be achieved by controlled assembly of zeolite crystals into an oriented structure. In the case of cylindrically shaped zeolite L, this implies the alignment of many crystals on a surface which would produce an alignment of a large number of one-dimensional channels.

The preparation of zeolite monolayers on a substrate has been disclosed in WO 01/96106 A1. However, this document relates to the deposition of small zeolite particles of various shapes and does not address their alignment with respect to the substrate and to each other.

### SUMMARY OF THE INVENTION

Accordingly, it is an object of the present invention to provide an assembly of zeolite crystals firmly attached to a substrate in such a way that the array of substantially parallel channels of each crystal is aligned substantially perpendicular to the substrate surface. Further objects of the invention are to provide a method for producing such an assembly.

According to one aspect of this invention, an oriented zeolite material comprises a plurality of zeolite crystals arranged on a substrate, each one of said crystals having a proximal face adjacent to said substrate and a distal face opposed therefrom and substantially parallel to said proximal face, each one of said crystals having a plurality of straight through uniform channels extending between the proximal face and the distal face and having a channel axis parallel to and a channel width transverse to a longitudinal crystal axis, each channel having a proximal channel end located at the proximal face and a distal channel end located at the distal face, each crystal being attached to the substrate by means of a linking layer that substantially occludes the proximal channel ends.

According to another aspect of this invention, a method for producing an oriented zeolite material comprises the steps of:
a) providing a substrate with a substantially flat surface;
b) providing an amount of zeolite crystals, each one of said crystals having a pair of substantially parallel faces, each one of said crystals further having a plurality of straight through uniform channels extending between said two faces and having a channel axis parallel to and a channel width transverse to a longitudinal crystal axis;
c) carrying out at least one of the following steps:
   c1) forming a layer of a substrate-affine linking agent on the substrate surface;
   c2) inserting a zeolite-affine linking agent into the channels of said crystals;
d) bringing together said crystals and said substrate, thereby inducing formation of a linking layer from said layer(s) of substrate-affine and/or zeolite-affine linking agent(s), said linking layer being arranged between the substrate and a proximal face of said face pairs.

Advantageous embodiments are defined in the dependent claims.

The substrate may be a modified or a non-modified glass or SiO₂, or TiO₂, or SnO₂, or ZnO, or Si, or Au, or Ag. This method may involve a modification of the substrate by employing covalent or molecular linkers such as C₆₀, or PEI, or GOP-TMS, or TES-PCN, or CP-TMS, or BTESB, or other molecules capable of providing a similar linkage to the surface of a substrate. In one embodiment of the invention, amino modified zeolite crystals were used. In another embodiment of the invention, an excess of zeolite L crystals was used to react with the substrate.

This invention furthermore provides methods to insert dyes into the open channel ends of the zeolite crystals of said monolayers. The invention furthermore provides methods to couple dye loaded zeolite monolayers to an external acceptor or donor stopcock dye at the channel ends. Said donor stopcock dye at the channel ends may trap electronic excitation energy from donor molecules inside the crystal or inject it to an acceptor inside the channels. In another respect, the invention is a material made by the above mentioned methods.

This invention furthermore provides materials that are the basis for systems where excitation energy is transported in one direction. Thus the material provided by the invention largely extends the possibilities to make use of the quasi 1D-electronic excitation energy transport in dye loaded zeolite L that has recently been observed (C. Minkowski, G. Calzaferri, Angew. Chem. Int, 2005, 44, 5325.). The highly organized robust materials described by the invention offer unique possibilities for developing photonic devices also comprising dye sensitized solar cells and luminescent solar concentrators (J. S. Batchelder, A. H. Zewail, T. Cole, Applied Optics, 1979, 18, 3090).

### BRIEF DESCRIPTION OF THE DRAWINGS

The above mentioned and other features and objects of this invention and the manner of achieving them will become more apparent and this invention itself will be better understood by reference to the following description of various embodiments of this invention taken in conjunction with the accompanying drawings, wherein:

FIG. 1 shows various stages in the preparation of an oriented zeolite material;

FIG. 2 shows various stages in the preparation of a dye loaded oriented zeolite material;

FIG. 3 shows a dye loaded zeolite material;

FIG. 4 shows SEM images of zeolite L monolayers after calcination, prepared by using: A) CP-TMS as a covalent linker under reflux; B) CP-TMS under sonication; and C) BTESB; each example comprises four images: upper row: 1 μm crystals at two different magnifications. lower row: disc-shaped crystals at two different magnifications;

FIG. 5 shows fluorescence microscopy images of monolayers loaded with one dye: a) Py⁺-zeolite L; and b) Ox⁺-zeolite L;

FIG. 6 shows excitation (dotted) and emission (solid) spectra of various dyes measured on oriented dye-zeolite L layers on quartz, with spectra scaled to the same height at the maxima: a) Py⁺-zeolite L (1) and Ox⁺-zeolite L (2); the emission and the excitation spectra of (1) were recorded upon excitation at 460 nm and detection at 560 nm, respectively; those of (2) were recorded upon excitation at 560 nm and detection at 640 nm, respectively. b) excitation and emission spectra of ATTO520 (1) and Cy02702 (2) attached to the zeolite L channel entrances; the emission and the excitation spectra of (1) were recorded upon excitation at 460 nm and detection at 600 nm, respectively; those of (2) were recorded upon excitation at 470 nm and detection at 630 nm, respectively;

FIG. 7 emission (upper) and excitation spectra (lower) of donor and acceptor loaded zeolite L crystals arranged as oriented monolayers on a glass plate; spectra have been scaled to the same height at the maxima; (A) spectra of a Ox⁺,Py⁺-zeolite L monolayer; the emission spectrum was recorded after selective excitation of Py⁺ at 460 nm and the excitation spectrum was detected at 680 nm, where Ox⁺ emits; B) spectra of a ATTO520,Ox⁺-zeolite L monolayer; the emission spectrum was recorded after selective excitation of ATTO520 at 460 nm and the excitation spectrum was detected at 680 nm, where Ox⁺ emits; C) spectra of a Cy02702,Py⁺-zeolite L monolayer; the emission spectrum was recorded after selective excitation of Py⁺ at 460 nm and the excitation spectrum was detected at 680 nm, where Cy02702 emits;

FIG. 8 steps for building up a thin-layer solar antenna based on a sensitized solid state solar cell;

FIG. 9 principle or thin-layer solar antennae: (A) photonic energy transfer from a photonic antenna to a semiconductor; (B) sensitized dye-solar cells.

### DETAILED DESCRIPTION OF THE INVENTION

### General Remarks

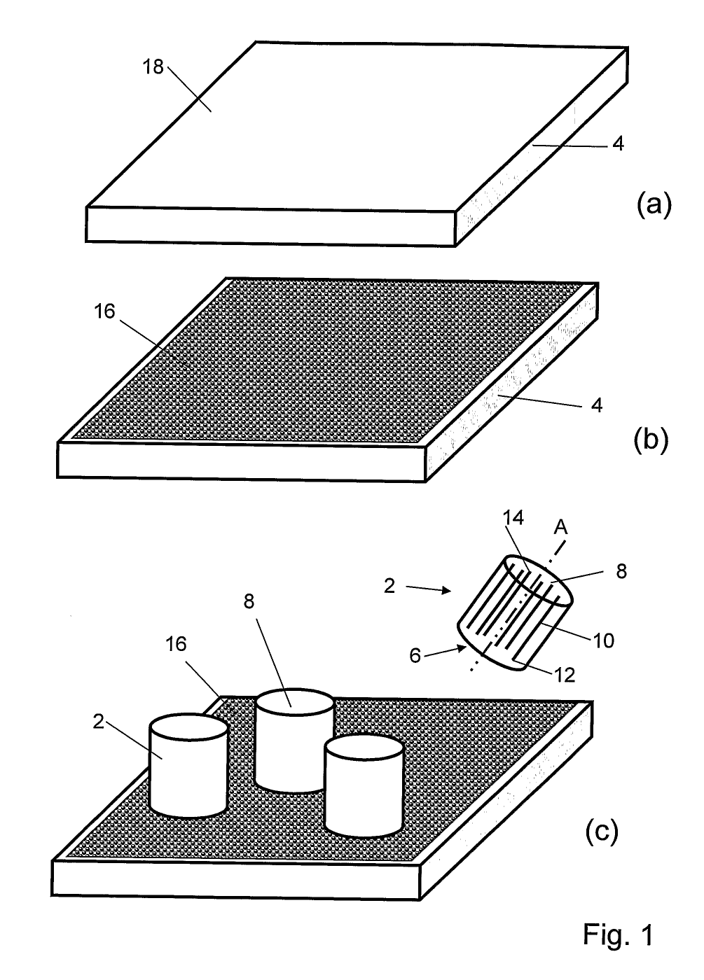

The general principle for building up an oriented zeolite material is shown in FIG. 1. The material comprises a plurality of zeolite crystals 2 arranged on a substrate 4, each one of said crystals having a proximal face 6 adjacent to said substrate and a distal face 8 opposed therefrom and substantially parallel to said proximal face. Each one of said crystals has a plurality of straight through uniform channels 10 extending between the proximal face and the distal face and having a channel axis parallel to and a channel width transverse to a longitudinal crystal axis A. Each channel has a proximal channel end 12 located at the proximal face and a distal channel end 14 located at the distal face, and each crystal is attached to the substrate by means of a linking layer 16 that substantially occludes the proximal channel ends. In particular, FIG. 1(a) shows the substrate 4 with a substantially flat surface 18, which is preferably pre-treated in order to remove any unwanted species, whereas FIG. 1(b) shows the substrate after application of the linking layer, details of which are discussed further hereinbelow. FIG. 1(c) shows the substrate with a few zeolite crystals attached thereto, with a further crystal shown in more detail.

The steps shown in FIG. 1 refer to a preparation method wherein the linking layer is formed from a substrate-affine linking agent that is brought into contact with the substrate surface. The term “substrate-affine” shall mean that the linking agent has an affinity to adhere to the substrate surface.

According to an alternative method not shown in FIG. 1, the linking layer is formed by first loading the zeolite crystals with a zeolite-affine linking agent. The term “zeolite-affine” shall mean that the linking agent can be introduced into the zeolite channels. In particular, the zeolite-affine linking agent will be a species that will lead to a functionalization of the channels' ends. In a next step, this linking agent interacts with the substrate surface so as to form a linking layer between the proximal face of the zeolite crystal and the substrate surface. The latter may be pre-coated with a substrate-affine linking agent.

When addressing zeolite crystals attached to a substrate, the term “proximal” will be generally used for any parts that are oriented towards the substrate whereas the term “distal” will be generally used for any parts that are oriented away from the substrate. In the case of a crystal that is not in contact with a substrate, there is no such distinction, so that it is appropriate to use terms such as “terminal” when addressing e.g. one of two equivalent crystal faces. It should also be noted that the substrate could be a flexible object, e.g. a ribbon-like structure.

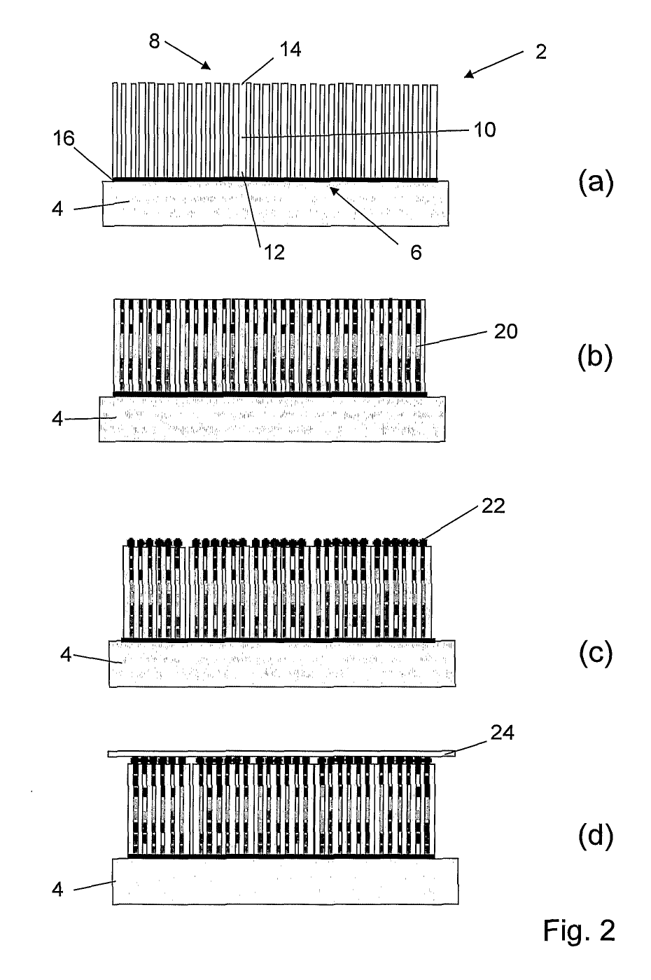

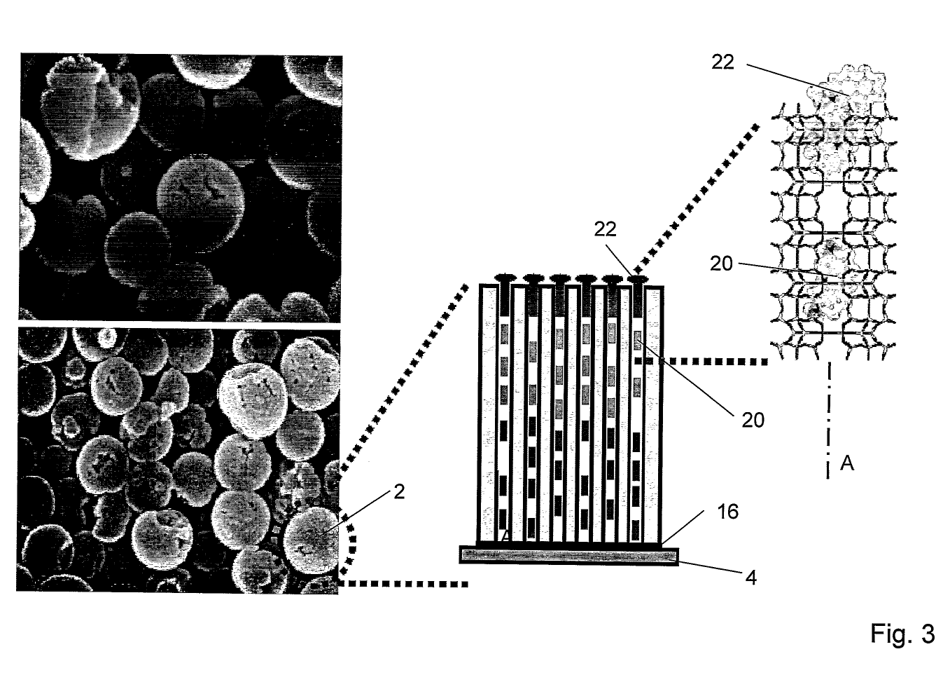

The oriented zeolite material prepared e.g. as in FIG. 1 may then be loaded with dye molecules, as shown schematically in FIGS. 2 and 3, wherein the same reference numerals are used as in FIG. 1 for equivalent features. The starting point shown in FIG. 2(a) is a zeolite L crystal 2 attached to a substrate 4 by means of a linking layer 16, wherein the latter effectively occludes the proximal channel ends 12. The distal channel ends 14 are open. Subsequently, dye molecules 20 are loaded into the channels 10 by using known techniques, thus reaching the situation shown in FIG. 2(b). Next, closure or “stopcock” molecules 22 are inserted in the distal channel ends 14 in plug-like manner, thus effectively enclosing the dye molecules as shown in FIG. 2(c). As an optional next step, a function layer 24 is laid over the array of closure molecules 22 as shown in FIG. 2(d).

The successful assembly of small zeolite crystals largely depends on the availability of a narrow size distribution and well defined morphology. The successful assembly of oriented zeolite L monolayers which can then be modified to result in organized supramolecular functional materials bears a new challenge. Table 1 gives an overview of different options for preparing such monolayers on a substrate. An underlying principle is that the interaction between the faces of the zeolite L crystals and the substrate is stronger than the interaction between the lateral surface of the zeolite L crystals and the substrate and, importantly, stronger than any interaction among the zeolite crystals. Working with an excess of crystals, fixing them in the right way to the substrate and washing away the excess material under these conditions may lead to the desired material. Subsequent insertion of dye molecules into the channels and addition of stopcocks may only be possible if the channels are not blocked or damaged during the preparation of the monolayer. The procedure may lead to materials with exciting properties, e.g. to systems where electronic excitation energy is transported in one direction only.

TABLE 1
Possible procedures for preparing zeolite monolayers

| | | |
|---|---|---|
| A | B | C |

Cleaning the substrate

| | | |
|---|---|---|
| Specific modification | Specific modification | Specific modification |
| of the substrate | of the zeolite | of both zeolite and |
| | | substrate |

Addition of an excess of zeolite suspended in an appropriate solvent
and reaction with the substrate
Migration and bond formation of the zeolite with the substrate
Monolayer assembly
Washing off the excess of zeolite crystals
Optional: Calcination at 600° C. under O₂ flow

TABLE 2
Molecules used in this study. Left: Dyes inserted in the channels of
zeolite L crystals on the monolayer. Right: Covalent linkers that have
been used to synthesize the monolayers. Bottom: ATTO520 and
Cy02702 are the stopcock molecules that have been attached to the
channel ends of the zeolites.

| Abbre- | | Abbre- | |
|---|---|---|---|
| viation | Structural Formula | viation | Structural Formula |
| Ox⁺ | 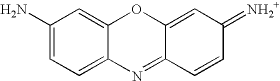 | C₆₀ | 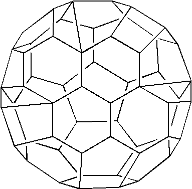 |
| Py⁺ | 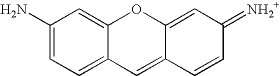 | GOP-TMS | 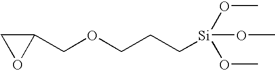 |
| MeAcr⁺ | 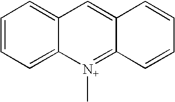 | PEI | 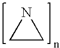 |
| DR1 | 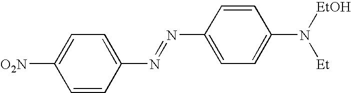 | TES-PCN | 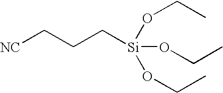 |
| DANS | 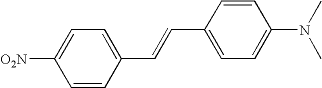 | CP-TMS | 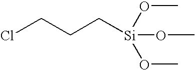 |
| DXP | 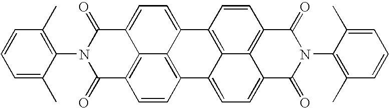 | BTESB | 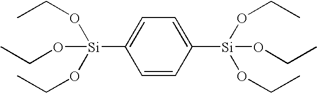 |
| Ox1 | 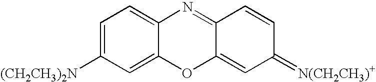 | Cy02702 | 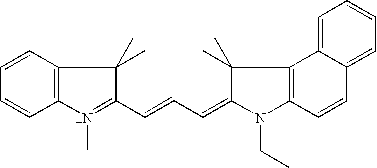 |
| ATTO520 | 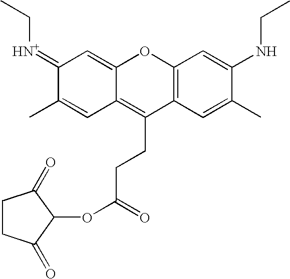 | | |

### Preparation of Zeolite L Monolayers

The preparation of zeolite L monolayers was carried out with two types of medium size cylindrically shaped zeolite L crystals: (a) 1 μm long crystals with an aspect ratio, i.e. a ratio of length to diameter, of 1, and (b) 200 nm long crystals with an aspect ratio of 0.3 (A. Zabala Ruiz, D. Brühwiler, T. Ban, G. Calzaferri, Monatsh. Chem. 2005, 136, 77). Depending on the reagents, different chemical procedures were followed. Incorporation of dyes and attachment of stopcock molecules at the channel ends, after calcining the monolayers of oriented zeolite L crystals led to monodirectional materials. The molecules that have been used as covalent linkers to synthesize the zeolite L monolayers, the dyes that have been inserted in the channels of zeolite L monolayers and the stopcock molecules that have been attached are collected in Table 2. The stability of the monolayers was tested before calcination by sonicating the samples in toluene. This test was used because sonication is the best way to clean the monolayers from an excess of crystals. The stability was always considerably improved by the calcination process.

Different experimental conditions and reagents have been tested for obtaining oriented zeolite L monolayers. We briefly describe the successful procedures and comment on the quality of the obtained materials before calcination. Details of the different procedures are reported in the experimental section.

(1) C₆₀: Based on a previous report (S. Y. Choi, Y.-J. Lee, Y. S. Park, K. Ha, K. B. Yoon, J. Am. Chem. Soc. 2000, 122, 5201) C₆₀ was tested as a covalent reagent for the preparation of zeolite L monolayers. The degree of coverage and the homogeneity of the monolayers is acceptable for some applications and the stability is high. It was possible to sonicate the sample for more than 10 minutes without damaging the layers.

(2) GOP-TMS: The degree of coverage, of close packing and the stability obtained with this linker is unsatisfactory. After few minutes of sonication basically all crystals fell off.

(3) PEI: Using PEI as a molecular linker (A. Kulak, Y. S. Park, Y.-J. Lee, Y. S. Chun, K. Ha, K. B. Yoon, J. Am. Chem. Soc. 2000, 122, 9308) we obtained a medium quality of coverage and close packing. Crystals are bound to each other in some areas. This hinders the formation of a clean monolayer which, however, is strongly bound to the glass surface; it was possible to sonicate the sample for more than 10 minutes without damaging the layer.

(4) TES-PCN: The degree of coverage and of close packing is high. The binding of the crystals to the glass surface is not very strong. Sonicating the sample for more than 5 minutes resulted in sever losses of crystals.

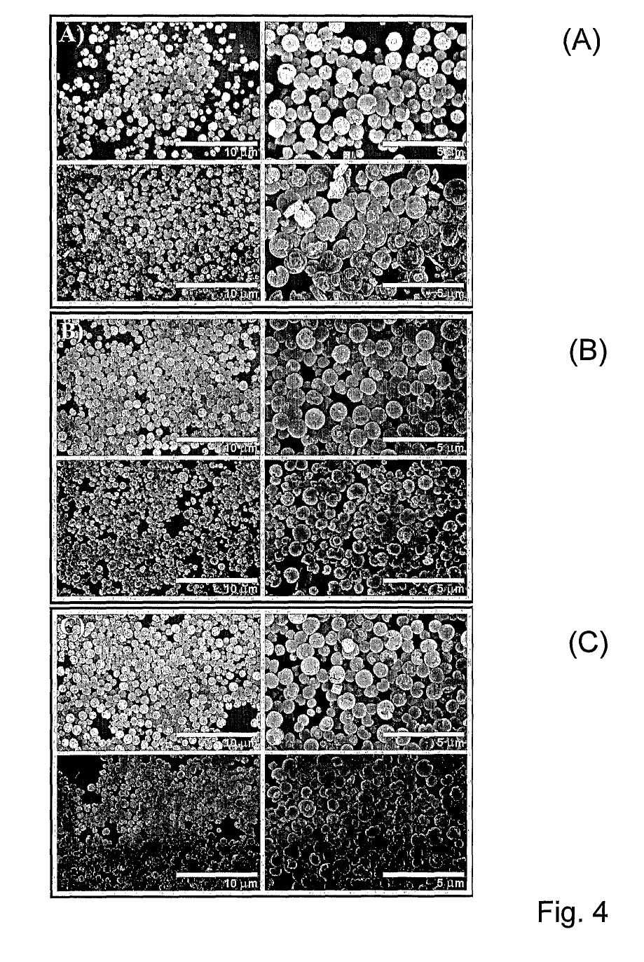

(5) CP-TMS: The reaction with CP-TMS comprises two steps: (see: S. Mintova, B. Schoeman, V. Valtchev, J. Sterte, S. Mo, T. Bein, Adv. Mater. 1997, 9, 585 and J. S. Lee, K. Ha, Y.-J. Lee, K. B. Yoon, Angew. Adv. Mater. 2005, 17, 837): i) Tethering CP-TMS to the glass surface. ii) Reaction of bare zeolite L with the CP-TMS-tethered glass plates. Both types of zeolite L yielded good quality monolayers. We tested two different ways of promoting the reaction between the zeolite L crystals and the functional groups tethered to the glass surface: reflux and sonication. FIG. 4A) shows the SEM images of samples prepared under reflux. The degree of packing and of coverage is good. However, when binding the zeolite crystals under sonication, both the degree of coverage and of packing is significantly higher, as shown in FIG. 4B). Carrying out the reaction under sonication turned out to be more convenient and also more successful; it involves considerable less reaction time. This way of reacting zeolite L with a surface modified glass plate was then applied in all other comparable procedures, e.g. when using GOP-TMS, TES-PCN, and BTESB. The binding between the zeolite L monolayer and the glass surface via CP-TMS seemed to be strong; the sample could be sonicated for more than 5 minutes.

(6) BTESB: A procedure that resulted in very good quality monolayers was by first tethering BTESB to the glass surface followed by reacting the bare zeolite L crystals with the BTESB-tethered glass plates under sonication. FIG. 4C) shows the SEM images of samples prepared with this method. The degree of coverage is high and the degree of close packing is very high. However, the stability of the so obtained zeolite L monolayers is less good than that obtained following procedure (5). Sonication of the sample for more than 3 minutes can cause a great loss of crystals.

We summarize that the procedures involving TES-PCN, CP-TMS and BTESB as covalent linkers, led to closely packed zeolite L monolayers with a very high degree of coverage over the whole plate. The binding of zeolite L crystals onto the TES-PCN/CP-TMS/BTESB-coated glass plate probably proceeds via nucleophilic substitution of the terminal cyanate/chloro/triethoxy groups, respectively, by the surface hydroxyl groups on the channel openings of zeolite L crystals. The strength of the binding between the zeolite monolayer and the glass surface is weak when using TES-PCN and BTESB whereas it is strong when using CP-TMS. It seems that the nucleophilic substitution of a terminal halide (K. Ha, Y.-J. Lee, H. J. Lee, K. B. Yoon, Adv. Mater. 2000, 12, 1114) induces much stronger binding between the zeolite L crystals and glass surface than the nucleophilic substitution of a terminal cyanate or triethoxy. The procedures involving C₆₀ and PEI as covalent linkers led to zeolite L monolayers with the strongest binding with the glass surface. The binding of amino modified zeolite L crystals onto the C₆₀-coated glass plate proceeds via amine addition to C₆₀ (K. Ha, Y.-J. Lee, H. J. Lee, K. B. Yoon, Adv. Mater. 2000, 12, 1114). The binding of GOP-TMS zeolite L crystals onto the GOP-TMS coated glass plate through PEI proceeds via nucleophilic ring opening of epoxy groups tethered on the glass and on the zeolite L surfaces by the amino groups of PEI (A. Kulak, Y. S. Park, Y.-J. Lee, Y. S. Chun, K. Ha, K. B. Yoon, J. Am. Chem. Soc. 2000, 122, 9308).

An important prerequisite for obtaining a high degree of coverage and of close packing is to use a considerable excess of zeolite L crystals when reacting them with the modified glass surface. Hence, an underlying principle that has to be respected is that the interaction between the base of the crystals and the substrate is preferably stronger or much stronger than any other interaction. A process to account for the close packing phenomenon is surface migration. It can take place if the interaction of zeolite L crystals with the modified glass plate is sufficiently weak at the initial state of the reaction so that migration can take place to form a dense package. In the next step stronger binding is achieved. Based on this we can understand why sonication is so successful in promoting the reaction during the monolayer assembly process. It helps the zeolite L crystals to rapidly find available sites on the surface by rapid surface migration.

### Dye-Loaded Zeolite L Monolayers

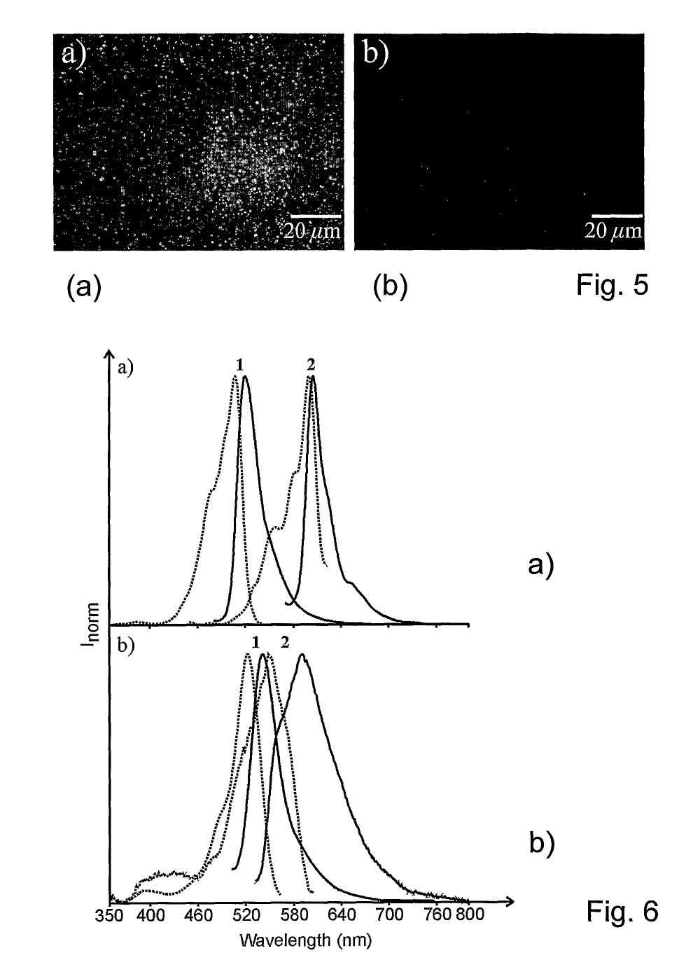

Having methods for preparing oriented zeolite L monolayers we can modify them by inserting dye molecules. For this purpose materials prepared according to procedures (5) or (6) were calcined in order to burn away the organic part and to better close the channel openings on the side in contact with the glass plate. Consecutive insertion of dyes was realized by similar procedures as described in G. Calzaferri, S. Huber, H. Maas, C. Minkowski, Angew. Chem. nt. Ed. 2003, 42, 3732 and M. Pauchard, A. Devaux, G. Calzaferri, Chem. Eur. J. 2000, 6, 3456). Table 2 shows a representative list of dyes we have inserted so far into the channels of zeolite L crystals organized as monolayer. FIG. 5 shows fluorescence microscopic images of two zeolite L monolayers loaded with Py+ and Ox+, respectively. Strong luminescence from the sample can be observed. This also proves that after the calcination process, the pores in the zeolite L crystals are still open.

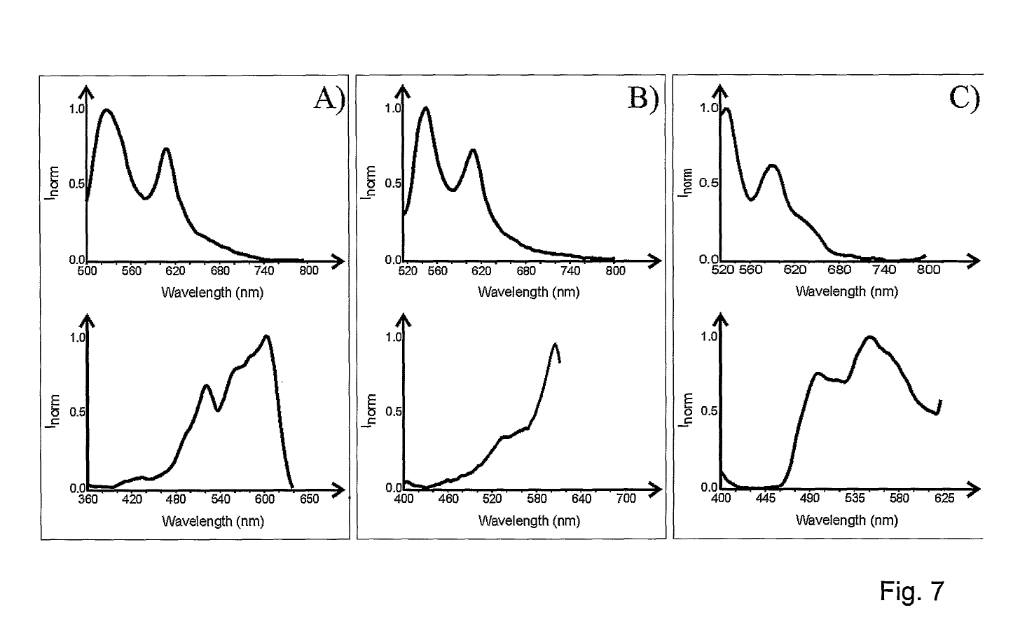

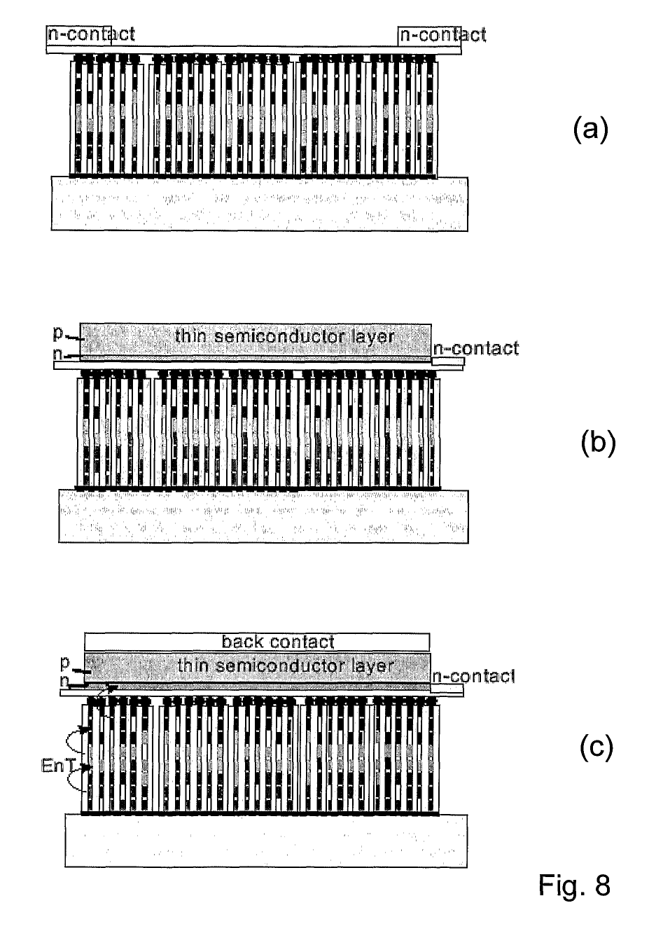

The consecutive insertion of two different dyes, which cannot glide past each other due to spatial restrictions, is the basis for the preparation of an antenna system capable of efficiently transporting electronic excitation energy. The Py+-Ox+ pair is a good choice for testing this. The high fluorescence quantum yield and the favorable spectral properties (see FIG. 5a)) of these dyes allow the system to have very efficient Förster type electronic excitation energy transfer. An oriented Ox+, Py+-zeolite L monolayer was prepared by first inserting Py+ (donors) followed by insertion of Ox+ (acceptors). The spectra shown in FIG. 7(A) illustrate that considerable energy transfer from the electronically excited Py+ to the Ox+ occurs after selective excitation of the donor. In this energy transfer experiment the emission spectrum was recorded upon excitation at 460 nm, where the absorption of Ox+ is very weak, and the excitation was detected at 680 nm, where the emission of Py+ is weak.

### Stopcock Modified Dye-Loaded Zeolite L Monolayers

Extension beyond the interior of the zeolite crystals is achieved by selectively positioning molecules at the entrances of the zeolite channels (see WO 02/36490 A1). Table 2 shows the two types of stopcock dyes that have been attached to the channel entrances of the zeolite L. The location of the stopcocks allows using them as traps or injectors of electronic excitation energy. We used ATTO520 to act as donor in a Ox+-zeolite L monolayer and Cy02702 to act as acceptor in a Py+-zeolite L monolayer. In both cases the spectral overlap between the donor emission and the acceptor excitation is considerable (see FIG. 6), so that energy transfer can occur upon selective excitation of the donor. FIGS. 7B) and 7C) illustrate that we can actually observe this. FIG. 7B shows the spectra of an oriented ATTO520,Ox+-zeolite L monolayer; the emission spectrum was recorded upon excitation at 460 nm, where the absorption of Ox+ is very weak, and the excitation was detected at 680 nm, where the emission of ATTO520 is weak. FIG. 7C) shows the spectra of an oriented Cy02702, Py+-zeolite L monolayer; the emission spectrum was recorded upon excitation at 460 nm, where the absorption of Cy02702 is very weak, and the excitation was detected at 680 nm, where the emission of Py+ is weak.

### EXAMPLES

### Materials

Zeolite L crystals of two different sizes (≈1×1 μm and 0.3×1 μm) were synthesized and characterized as described previously (A. Zabala Ruiz, D. Brühwiler, T. Ban, G. Calzaferri, Monatsh. Chem. 2005, 136, 77). Py⁺ acetate and Ox⁺ perchlorate were synthesized and purified according to: H. Maas, A. Khatyr, G. Calzaferri, Micropor. Mesopor. Mater., 2003, 65, 233. ATTO520 was purchased from ATTO-TECH GmbH. Cy02702 iodine was obtained from Clariant (S. J. Mason, S. Balasubramanian, Org. Lett, 2002, 4, 4261). APS (Fluka, purum≧98%), GOP-TMS (Fluka, purum≧97%), PEI (Aldrich, high molecular weight, water free), TES-PCN (Aldrich, ≧95%), CP-TMS (Aldrich, ≧97%), BTESB (Aldrich, 96%). Toluene (Fluka, puriss., absolute, over molecular sieve), ethanol (Fluka, absolute, 99.8%), methanol (Fluka, purum), acetonitrile (Fluka, puriss., 99.5%, over molecular sieve), and doubly distilled water. The substrates were round glass plates (Ø=10 mm, thickness=1 mm, TRABOLD, Switzerland).

### Preparation of the Zeolite L Monolayers.

### C₆₀ as Covalent Linker:

1) Functionalization of the channel entrances of zeolite L with amino groups was done as described in an earlier report (S. Huber, G. Calzaferri, Angew. Chem. Int, 2004, 43, 6738).
2) Tethering APS to the glass surface: Typically, two pieces of glass plates supported on a Teflon mount were immersed in a toluene solution (30 mL) of APS (50 μL) in a round-bottomed Schlenk flask and refluxed for 1 h under N₂, cooled to room temperature and washed with toluene and with copious amounts of ethanol. The APS tethered glass plates were finally dried for approximately 2 h at 80° C. in air.
3) Reaction of C₆₀ with APS tethered glass plates: C₆₀ (1 mg) was added to a 15 mL toluene solution in a round-bottomed Schlenk flask; a glass plate was then introduced and the mixture was refluxed for 24 h under N₂, cooled to room temperature and washed with copious amounts of cholorobenzene.
4) Reaction between amino-modified zeolite L with C₆₀ coated glass substrate: An excess of amino-modified zeolite L (between 10 and 11 mg) was added to a toluene (15 mL) solution in a round-bottomed Schlenk flask and sonicated for 15 min after which a C₆₀ coated glass substrate was introduced. The mixture was refluxed for 5 h under N₂, cooled to room temperature and sonicated in fresh toluene for 3 min in order to remove the physisorbed zeolites.

### PEI as Molecular Linker:

1) Tethering GOP-TMS to the zeolite L: Zeolite L (50 mg) was suspended in a toluene solution (20 mL) of GOP-TMS (0.1 M) in a round-bottomed Schlenk flask and refluxed for 3 h, cooled to room temperature and the GOP-TMS tethered zeolite crystals were washed with ethanol.
2) Tethering GOP-TMS to the glass surface: 2 pieces of glass plates supported on a Teflon mount were immersed into a toluene solution (20 mL) of GOP-TMS (0.1 M) in a round-bottomed Schlenk flask and the toluene solution was refluxed for 3 h, cooled to room temperature and then the GOP-TMS-tethered glass plates were washed with toluene.
3) Attachment of PEI to GOP-TMS tethered glass plates: 2 pieces of GOP-TMS tethered glass plates were immersed in a toluene solution (20 mL) of PEI (700 mg) and refluxed for 2 h. the physisorbed PEI was removed by repeated washing with hot ethanol and doubly distilled water.
4) Reaction of amino-modified zeolite L with GOP-TMS-PEI coated glass plates: An excess of amino-modified zeolite L (15 mg) was added to a toluene (15 mL) solution in a round-bottomed Schlenk flask and sonicated for 15 min after which a GOP-TMS-PEI coated glass plate was introduced. The mixture was refluxed for 3 h under N₂. After cooling to room temperature, the zeolite L coated opaque glass plates were sonicated in fresh toluene for 3 min in order to remove the physisorbed zeolites.

### GOP-TMS, TES-PCN, CP-TMS and BTESB as Covalent Linkers:

1) Tethering ethoxy-methoxysilane reagent to the glass surface: Typically, two pieces of glass plates supported on a Teflon mount were immersed in a toluene solution (20 mL) of ethoxy-methoxysilane reagent (0.1 M) in a round-bottomed Schlenk flask and refluxed for 3 h. The ethoxy-methoxysilane-tethered glass plates were washed with toluene.
2a) Reaction of bare zeolite L with ethoxy-methoxysilane tethered glass plates under reflux: An excess of zeolite L (10 to 13 mg) was added to a toluene solution (10 mL) in a round-bottomed Schlenk flask and sonicated for approximately 40 min. An ethoxy-methoxysilane tethered glass plate was introduced and refluxed for 3 h. The zeolite L coated opaque glass plates were sonicated in fresh toluene for maximum 1 min in order to remove the physisorbed zeolites.
2b) Reaction of zeolite L with ethoxy-methoxysilane tethered glass plates under sonication: An excess of zeolite L (10 to 13 mg) was added to a toluene solution (10 mL) in a round-bottomed Schlenk flask and sonicated for approximately 40 min. An ethoxy-methoxysilane tethered glass plate was introduced and sonicated for 15 to 17 min. The zeolite L coated opaque glass plates were sonicated in fresh toluene for maximum 1 min in order to remove the physisorbed zeolites.

### Calcination of Zeolite L Monolayers

The zeolite L monolayer was placed in a closed oven and the temperature was steadily increased up to 600° C. under oxygen atmosphere where it was kept for 3 h. After calcination the zeolite L monolayer was dipped in a 0.1 M KNO₃ solution for 30 min.

### Functionalization of the Zeolite L Monolayers

The cationic dyes were inserted into the zeolite L channels by ion exchange from aqueous solutions. A calcined zeolite L monolayer was introduced in an aqueous solution of Py⁺ or Ox⁺ and heated up to 70° C. for 15 h. The zeolite L monolayer was then several times washed with doubly distilled water and with ethanol. Neutral dyes like DR1 and DANS were inserted from the gas phase following the single ampoule method, as described in earlier reports (G. Calzaferri, S. Huber, H. Maas, C. Minkowski, Angew. Chem. Int. Ed. 2003, 42, 3732, C. Minkowski, R. Pansu, M. Takano, G. Calzaferri, Adv. Func. Mater. 2005, early view and M. Pauchard, A. Devaux, G. Calzaferri, Chem. Eur. J. 2000, 6, 3456). The reaction time and temperature were 48 h at 170° C. for DR1 and 24 h at 270° C. for DANS respectively.

### Attachment of Stopcock Dyes at the Channel Ends

Attachment of ATTO520 to the channel ends was achieved by introducing a zeolite L monolayer in an acetonitrile solution of ATTO520 for 24 h at room temperature as described in WO 02/36490 A1. For the electrostatic binding of the cationic dye Cy02702, a zeolite L monolayer was introduced in an ethanol solution of Cy02702 for 24 at room temperature.

### Physical Measurements

SEM measurements were carried out by means of scanning electron microscopy with a Hitachi S-3000N at an acceleration voltage of 20 kV. A 3 nm gold layer was deposited on top of the samples. Luminescence and excitation spectra were measured at room temperature in air with a Perkin-Elmer LS 50B instrument with a resolution of 15 nm. For the luminescence microscopic images an Olympus BX60 microscope equipped with a Kappa CF20DCX air-cooled CCD camera was used. The Py⁺-zeolite L monolayer sample was excited from 470 to 490 nm and the fluorescence was detected by using a 520 nm cut off filter. The Ox⁺-zeolite L monolayer sample was excited from 545 to 580 nm and the fluorescence was detected by using a 610 nm cut off filter. The quality of the zeolite L monolayers was examined by dipping the zeolite L coated glass plates in fresh toluene and immersing them in an ultrasonic bath (Branson DTH-2510, 130 W, 42 kHz) for several minutes. The glass plates were then investigated by means of an optical microscope.

### Further Applications of Oriented Dye Loaded Zeolite Materials

The following applications rely on the unique properties afforded by the oriented zeolite materials according to this invention. It will be understood that additional principles, such as e.g. the loading of zeolite channels with a sequence of different dye molecules having specific photoabsorption or photoemission properties will be used. The basic principle in this latter respect has been outlined in WO 02/36490 A1, the content of which is explicitly included herein by reference.

### Sensitized Solid State Solar Antenna

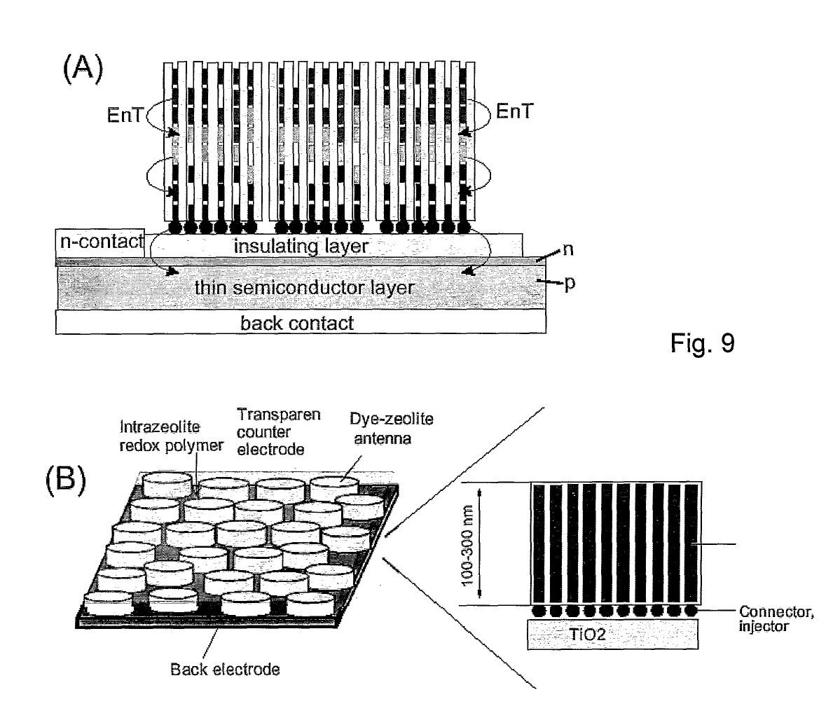

The steps for building up a dye-sensitized solar antenna are shown in FIG. 8. Starting from the assembly shown in FIG. 2(d), the functional layer 24 added onto the closure molecules 22 is a thin insulating layer such as a polymer or SiO₂ that may be added either from a solution or from the gas phase. Subsequently, as shown in FIG. 8(a) an n-contact is added onto the insulating layer, e.g. by means of lithography or bubble jet or ink jet techniques. Thereafter, as shown in FIG. 8(c), a doped semiconductor layer such as silicon or a semiconducting polymer is applied on top of the n-contact. Typically, the semiconductor layer has a thickness of about one micrometer, so that the entire active layer has a thickness of about 2 micrometer. Silicon may be applied from the gas phase whereas polymers are usually applied from a solution or suspension. Finally, a back contact is applied onto the doped semiconductor layer. The device is further illustrated in FIG. 9. The antenna system absorbs light passing through a transparent upper electrode and transports the photonic energy mainly along the longitudinal zeolite crystal axis to the semiconductor layer. Electron-hole pairs are thus formed in the semiconductor by energy transfer from the antenna system to the conduction band of the semiconductor.

### Light Emitting Diode Sensitized Emission

The build up of such a device relies on the same steps as shown in FIG. 8, with the only difference that an opposite ordering concerning the magnitude of the HOMO-LUMO distance of the dye and the band gap in the semiconductor must be chosen. The band gap of the semiconductor must have a size that allow for a transfer of electronic excitation onto the stopcock molecule. The chromophores adjacent to the stopcock molecules must be able to take over electronic energy from the latter.

### Anisotropic Radiation Converter for Light Management

Material formed in analogous fashion as explained in FIG. 8 may be used for light management, for example in greenhouses, if an appropriate sequence of dye molecules and an appropriate substrate is used. In such a material, short wave light impinging from one side will be absorbed and subsequently emitted as “red-shifted” light with a longer wavelength on the other side of the material. The wavelength range of the reemitted luminescence light may be adapted to the requirements of any particular application by suitable choice of dye molecules. The minimum size of such a material is limited to the size of the zeolite crystals and thus is in the order of submicrometers or micrometers. The maximum size is virtually unlimited and may certainly be several square meters.

### Oriented Dye Und Stopcock Molecule Modified Zeolite L Monolayers as Sensor Matrix for Analytical Purposes

The build-up corresponds to the steps in FIG. 2. The characteristics of the stop-cock molecules define the specificity of the sensor. Further information is provided in Example 2 of WO 02/36490 A1.

Oriented Dye Modified Zeolite L Monolayer Arrays in which Each Dye Loaded Zeolite L Crystal Works as a Laser

The build-up corresponds to the steps shown in FIG. 2 and optionally the step shown in FIG. 8 (a). In some cases it is advantageous to add a further layer in order to optimize the resonator properties of the dye loaded zeolite crystals.

It will be appreciated that modifications to the embodiments described above are of course possible. Accordingly the present invention is not limited to the embodiments described above.

1. An oriented zeolite material, comprising a plurality of zeolite crystals (2) arranged on a substrate (4), each one of said crystals having a proximal face (6) adjacent to said substrate and a distal face (8) opposed therefrom and substantially parallel to said proximal face, each one of said crystals having a plurality of straight through uniform channels (10) extending between the proximal face and the distal face and having a channel axis parallel to and a channel width transverse to a longitudinal crystal axis A, each channel having a proximal channel end (12) located at the proximal face and a distal channel end (14) located at the distal face, each crystal being attached to the substrate by means of a linking layer (16) that substantially occludes the proximal channel ends.

2. The oriented zeolite material according to claim 1, wherein said substrate is glass or quartz.

3. The oriented zeolite material according to claim 1, wherein said linking layer comprises C₆₀.

4. The oriented zeolite material according to claim 1, wherein said linking layer comprises a linking agent selected from the group consisting of PEI, GOP-TMS, TES-PCN, CP-TMS and BTESB.

5. The oriented zeolite material according to claim 1, wherein said channels contain a substantially linear arrangement of luminescent dye molecules, said arrangement exhibiting properties related to supramolecular organization.

6. The oriented zeolite material according to claim 5, further comprising a plurality of closure molecules having an elongated shape and consisting of a head moiety and a tail moiety, the tail moiety having a longitudinal extension of more than a dimension of the crystal unit cells along the longitudinal crystal axis and the head moiety having a lateral extension that is larger than said channel width and will prevent said head moiety from penetrating into a channel, a channel being terminated, in generally plug-like manner, at the distal end thereof, by a closure molecule whose tail moiety penetrates into said channel and whose head moiety substantially occludes said distal channel end while projecting over said distal face.

7. The oriented zeolite material according to claim 6, further comprising at least one functional layer overlayed on the plurality of said head moieties occluding said distal channels.

8. A method of producing an oriented zeolite material, comprising the steps of:
a) providing a substrate with a substantially flat surface;
b) providing an amount of zeolite crystals, each one of said crystals having a pair of substantially parallel faces, each one of said crystals further having a plurality of straight through uniform channels extending between said two faces and having a channel axis parallel to and a channel width transverse to a longitudinal crystal axis;
c) carrying out at least one of the following steps:
c1) forming a layer of a substrate-affine linking agent on the substrate surface;
c2) inserting a zeolite-affine linking agent into the channels of said crystals;
d) bringing together said crystals and said substrate, thereby inducing formation of a linking layer from said layer(s) of substrate-affine and/or zeolite-affine linking agent(s), said linking layer being arranged between the substrate and a proximal face of said face pairs.

9. The method according to claim 8, wherein said step c) comprises sonicating said crystals and said substrate.

10. The method according to claim 8, wherein said step d) comprises a calcination step.

11. The method according to claim 8, wherein at least part of the steps are carried out in a solvent.

12. The method according to claim 8, further comprising the step of filling a plurality of dye molecules into said channels.

13. The method according to claim 8, further comprising the step of adding closure molecules having an elongated shape and consisting of a head moiety and a tail moiety, the tail moiety having a longitudinal extension of more than a dimension of the crystal unit cells along the longitudinal crystal axis and the head moiety having a lateral extension that is larger than said channel width and will prevent said head moiety from penetrating into said channel, said channel being terminated, in generally plug-like manner, at the distal end thereof located at a distal face of said face pair, by a closure molecule whose tail moiety penetrates into said channel and whose head moiety substantially occludes said distal channel end while projecting over said distal face.

14. The method according to claim 12, further comprising the step of adding at least one functional layer onto the plurality of said head moieties occluding said distal channels.
